(19) United States
(12) Patent Application Publication
(10) Pub. No.: US 2005/0050780 A1
(43) Pub. Date: Mar. 10, 2005

(54) Sign system and method of using same

(76) Inventor: Frank Schlachta, Smiths Falls (CA)

Correspondence Address: Norman P. Soloway;HAYES SOLOWAY P.C., 130 W. Cushing Street, Tucson, AZ, 85701, US

(21) Appl. No.: 10/936,988

(22) Filed: Sep. 9, 2004

(30) Foreign Application Priority Data
Sep. 9, 2003 (CA) 2,440,119

(51) Int. Cl. G09F 13/00

(52) U.S. Cl. 40/547; 40/607.06

(57) ABSTRACT

A sign system has a support and a panel unit supported by the support. The panel unit has one or more panels for presenting information thereon. The sign system further has an anchoring system for anchoring the support to the ground, and a lighting system. The lighting system has an optical fibre unit provided in the panel unit. The optical fibre unit has one or more optical fibre rods with a rough peripheral surface or with translucent tape affixed or is clear and smooth for illuminating the information on the panels.

### BACKGROUND OF THE INVENTION

A typical sign for advertisement, such as a real estate sign, has an inversed-L-shaped post and a sign panel hung from a side bar section of the post. The post is made with a rod having a square or rectangular cross-section. In order to hold the sign on the ground, an elongated member having a T-shaped cross section is staked into the ground, and the bottom part of the support is mounted on the T-shape member. This type of sign is sufficient when the ground condition is ideal, e.g., flat and dry. However, when the sign is provided in a windy location or in a soggy ground, the sign often become unstable and tend to tilt or even fall down.

Many signs use a simple board with affixed advertising text, which are not effective during night. It is proposed to use a sign system that incorporates a lamp. In some proposals a lamp is provided to illuminate the sign from outside, and in another proposal a lamp is provided between two panels of advertisement as a back lamp. Those advertisements are efficient during the night as well as during the daytime. However, the lamps used in those proposals are traditional lamps, such as halogen lamps and neon bulbs, which consume relatively large amount of energy. Accordingly, they were not usable in many locations where no electrical outlet is available. While it was proposed to use solar panels to provide energy to the sign system, such a sign system was not practically used due to the high energy consumption of the lamps in the sign system.

### SUMMARY OF THE INVENTION

It is an object of the invention to provide a novel sign system that obviates or mitigates at least one of the disadvantages of existing systems.

The sign system uses an optical fibre (or lucite or other plastic or glass rod material as appropriate for the needed lighting conditions for the sign panel collectively referred to herein as “optical fibre”) unit for illuminating information on a sign panel. In a preferred embodiment, the sign system uses an anchoring system having Z-shaped anchoring legs.

In accordance with an aspect of the present invention, there is provided a sign system comprising a support and a panel unit supported by the support. The panel unit has one or more panels for presenting information thereon. The sign system further has both an anchoring system for anchoring the support to the ground, and a lighting system. The lighting system has an optical fibre unit provided in the panel unit. The optical fibre unit has one or more optical fibre rods with a roughened peripheral surface, affixed translucent tape or clear smooth surface for illuminating the information on the panels. The optical fibre rods provide an energy efficient means of distributing the light energy from low current drain light sources (LEDs, low power bulbs, etc.) and thereby illuminating sign panels by means of solar panel charged and recharged batteries.

Other aspects and features of the present invention will be readily apparent to those skilled in the art from a review of the following detailed description of preferred embodiments in conjunction with the accompanying drawings.

### BRIEF DESCRIPTION OF THE DRAWINGS

The invention will be further understood from the following description with reference to the drawings in which:

FIG. 1 is a schematic view of a sign system in accordance with an embodiment of the present invention;

FIG. 2 is a schematic view of an anchoring system used in the sign system;

FIG. 3 is a top view of the anchoring system;

FIG. 4 is a partial view showing an example of installation of the sign system;

FIG. 5 is an enlarged view showing an anchoring leg;

FIG. 6 is an enlarged view showing a different anchoring leg;

FIG. 7 is a partial view showing another example of installation of the sign system;

FIG. 8 is a schematic view of a panel unit of the sign system;

FIG. 9 is a partial view of the panel unit;

FIG. 10 is a schematic view of an optical fibre unit;

FIG. 10A is a partial cross sectional view of the lower section of the panel unit as seen from line A-A in FIG. 10;

FIG. 11 is an enlarged view of an optical fibre rod;

FIG. 11A is an enlarged view of an optical fibre rod with translucent tape affixed;

FIG. 11B is an enlarged view of an optical fibre rod with smooth, clear outer surface;

FIG. 12 is a block diagram showing a lighting system;

FIG. 13 is a schematic diagram showing a sign system in accordance with another embodiment of the invention;

FIG. 14 is a schematic diagram showing a sign system in accordance with another embodiment of the invention; and

FIG. 15 is a schematic diagram showing a sign system in accordance with another embodiment of the invention.

### DETAILED DESCRIPTION OF THE PREFERRED EMBODIMENTS

Referring to FIG. 1, a sign system 10 in accordance with an embodiment of the present invention is described.

The sign system 10 has an inversed L-shaped support 12 and a panel unit 14 mounted on or hanged from the support 12. Also, the sign system 10 has a lighting system as further described referring to FIG. 9 below.

The L-shaped support 12 has an L-shaped hollow post 20 and an anchoring system 30 as better seen in FIG. 2. The hollow post 20 has a horizontal section 22 (FIG. 1) and a perpendicular section 24 connected to the horizontal section 22 at an end or adjacent to the end. The anchoring system 30 is provided at the lower end of the perpendicular section 24.

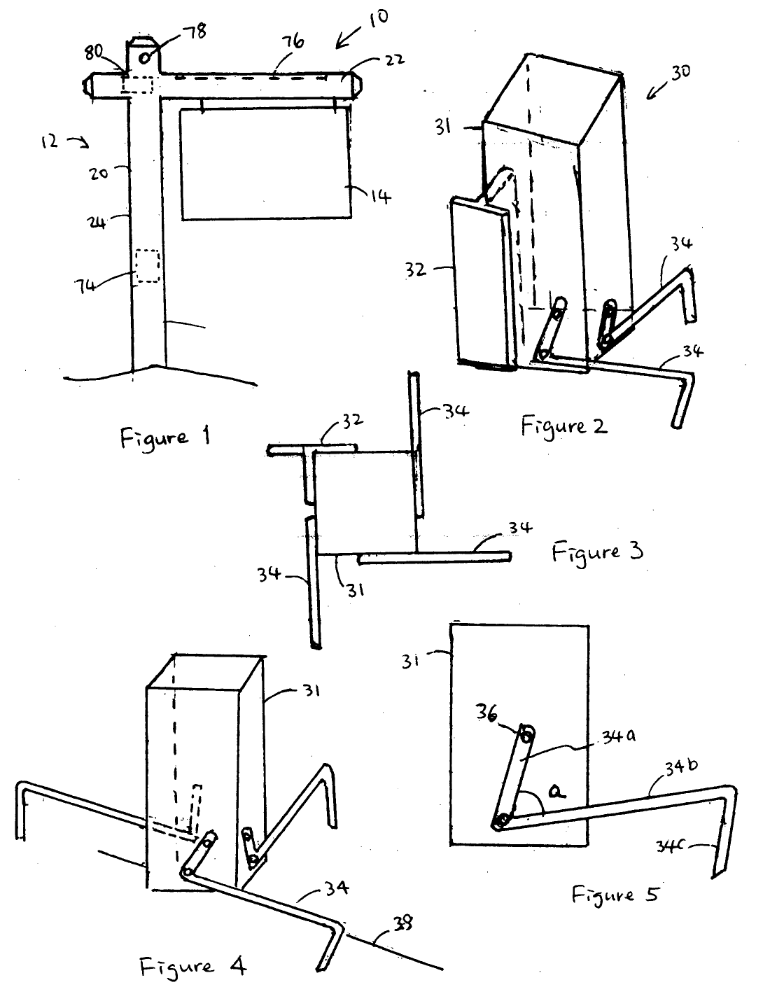

According to an embodiment of the invention, as shown in FIGS. 2-5, the anchoring system 30 includes a coupling member 31 and one or more anchoring legs 34. It may also have a T-shaped member or T-bar 32 staked into the ground, as shown in FIGS. 2 and 3.

Each anchoring leg 34 has three sections connected to generally form a Z-shaped member. As best shown in FIG. 5, two end sections 34a and 34c are connected to middle section 34c at a preset angle a. One end section 34a has means 36, e.g., holes for screws, for securing it to the coupling member 31. The other end section 34b is staked into the ground.

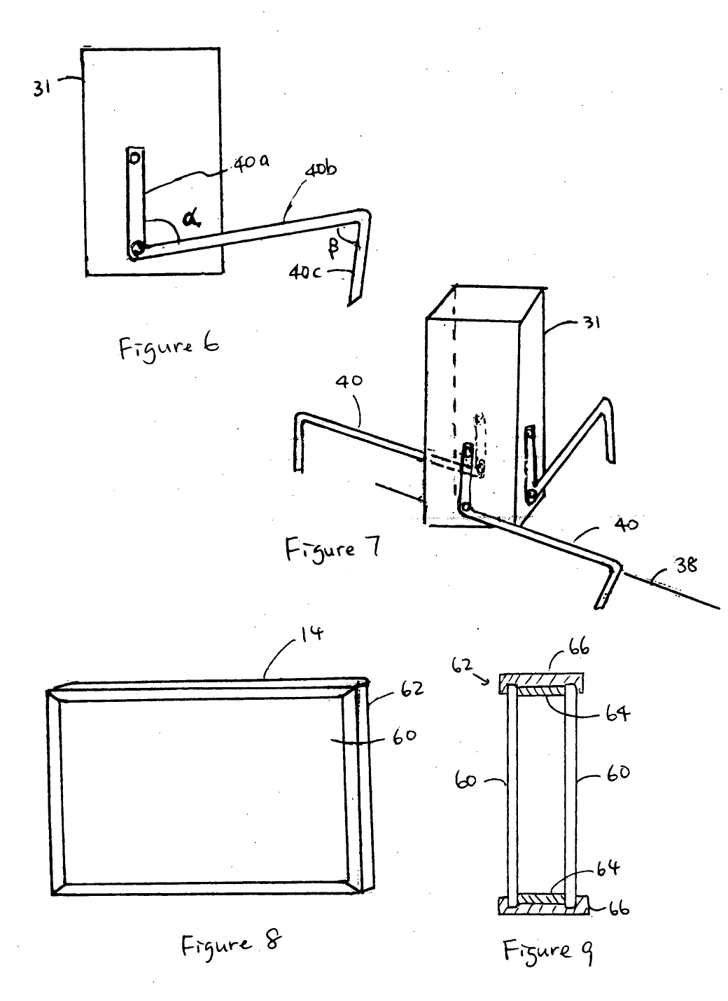

When installing the sign, depending on the ground condition on which the sign system 10 is to be mounted, the orientation of anchoring legs 34 is adjusted so that the sign system 10 is held stable in a desired position, and then the anchoring legs 34 are fasten to the coupling member 31 with, e.g., screws. Thus, the sign system 10 can be used on a uneven ground. For example, as shown in FIG. 4, when the ground 38 is sloped, the orientation of each anchoring leg can be adjusted such that the middle sections 34b are generally parallel to the ground 38 to hold the sign system 10 straight. The middle sections 34b may be exposed over the ground (e.g. FIG. 4) or buried under the ground surface (e.g. FIG. 1).

Typically one or three anchoring legs are used to suitably hold the sign system when a T-bar is used. When the sign system does not use a T-bar, typically 2 or 4 anchoring legs are used. More anchoring legs may be used to improve rigidity depending on the condition of the ground.

The coupling member 31 may have any cross sectional shape and may be made of any suitable materials. A wooden block may be used suitably as a coupling member 31.

Once the anchoring system 30 is mounted on the ground, the sign system 10 may be installed such that the L-shaped hollow post 24 covers the anchoring system 30, i.e., coupling member 31, T-bar 32 and the first end section 34a of the anchoring legs 34 secured on the holding member 32. The middle section 34b and the other end section 34c of each anchoring leg 34 are typically extending outwardly from the hollow post 24.

The dimensions of the hollow post 24 and each component of the anchoring system 30 are determined such that the anchoring system 30 slidably fits into the hollow post 34 during the Installation of the sign system 10. When the hollow post 24 is fixed on the anchoring system 30 by slidable fitting only, the diameter of the central hole of the hollow post 24 should be small enough and the length of the coupling member 31 is long enough so that the sign system 10 is held stable by the anchoring system 30. Screws or other securing means may be used to secure the hollow post 24 to the coupling member 31 for improving stability of the sign system 10.

In the above embodiment, the anchoring legs are mounted on the coupling member 31. In a different embodiment, an anchoring system may be used directly on the hollow post. In that case, the anchoring system may be attached to the hollow post prior to mounting the sign system on the ground.

In a different embodiment, rather than using anchoring legs having fixed angled end sections, adjustable anchoring legs 40 are used as shown in FIGS. 6 and 7.

In this embodiment, each adjustable anchoring leg 40 generally has a Z-shape and has three sections, as best shown in FIG. 6. The first section 40a is secured to the support 10, and the third section 40c is adapted to be inserted into the ground. The second or middle section 40b connects the first and third sections 40a, 40c.

The angle α (FIG. 6) between the first section 40a and the second section 40b can be selected among various anchor legs available depending on the conditions of the ground on which the sign system is to be mounted, so that the sign system can be held in a desired position. Thus the sign system can be used on a uneven ground. For example, as shown in FIG. 7, when the ground is sloped, one anchoring leg may be adjusted to have a smaller angle between the first section 40a and the second section 40b and another anchoring leg may be adjusted to have a larger angle between the first and second sections so that the sign system can stand straight. The second sections may be exposed over the ground (e.g. FIG. 7) or buried under the ground surface.

Similarly, the angle β (FIG. 6) between the third section 40c and the second section 40b may also be adjustable.

As shown in FIGS. 8 and 9, the panel unit 14 comprises a pair of translucent sign panels 60 on which signs, such as advertisement or information, are provided. The pair of sign panels 60 are spaced apart each other and supported in place by a frame member 62.

The frame member 62 may comprise four frame sections having grooves on internal walls or any other suitable method clear to one practiced in the art to secure the sign panels at a predetermined distance apart. Thus, sign panels 60 are easily exchanged with different sign panels for different advertisements or information.

The frame member 62 may have multiple components. For example, a spacing frame and a covering frame may be used. FIG. 9 shows an example of a frame member comprising two components suitably used for a 24″×32″-sign panel 60. A wooden frame 64 having members with ¼″ thickness and 1″ width is suitably used to position the pair of the sign panels 60 with a suitable space, and a plastic frame 66 covers the wood frame 64 and the peripherals of the sign panels 60 or any other suitable method clear to one practiced in the art.

Referring to FIGS. 10-12, the lighting system is now described. The lighting system 70 comprises an optical fibre unit 72, rechargeable battery unit 74, solar panel 76, switching unit 78 and controller 80.

The optical fibre unit 72 is provided in the space between two sign panels 60 to provide a back light to illuminate the sign panels from the inside of the panel unit. As shown in FIG. 10, the optical fibre unit 72 has one or more optical fibre rods 82 and one or more Light Emitting Diodes (LEDs) or other illuminating devices such as incandescent or other bulbs and lamps 84 to power the optical fibre rods 82.

The optical fibre rods 82 are arranged generally in parallel to the sign panels 60. The optical fibre rods 82 convey the LED (or other illuminating devices) light energy efficiently enough to illuminate the sign panels 60 with little energy needed for LEDs (or other illuminating devices). Thus, the solar panel 76 can provide sufficient energy to charge battery 74 for the purpose of illuminating the panels 60 via the optical fibre rods 82 and the LEDs 84 (or other illuminating device).

The optical fibre rods 82 are solid and clear rods that may be made of glass or plastic. As shown in FIG. 11, the peripheral surface 82a of each optical fibre rod 82 is roughened or has translucent tape affixed or is smooth and clear surfaced so that light running through the optical fibre rod diffuses from the peripheral surface as required for the illumination of the sign panels 60. In FIG. 11, the roughened surface is represented with dots on the peripheral surface 82a. Thus, the optical fibre rod can emit light through the peripheral surface to illuminate the sign panels provided generally parallel to the optical fibre rod. The optical fibre rod surface may be roughened by abrading with sand paper or by bead blasting or may have translucent tape affixed or may be smooth and clear.

The distribution of the fibre rods 82 and LEDs 84 within the panel unit may be determined by the desired sign design. For example, as shown in FIG. 7, for a standard sized sign panel of 24 inches×32 inches, 12 inch fibre rods may be arranged 6 inches apart in two rows. An LED or other illuminating device may be provided at both ends of each column and the middle of each column, i.e., the middle of two rows. The length and number of each fibre rod and the number of the rows in a panel unit may be varied depending on the desired illumination effects. The fibre rods 82 and LEDs 84 are held together with wire, carbon fibre, tape or suitable other material.

The optical fibre unit 72 also includes a convex reflecting material 86 at the inside of the frame 62 adjacent the ends of columns of fibre rods 82, as best seen in FIG. 10A. The convex reflecting material 86 reflects the light coming out through the ends of the optical fibre rods 82. The curvature or bend of the convex reflecting material 86 is determined to effectively reflect the light towards the sign panels 60.

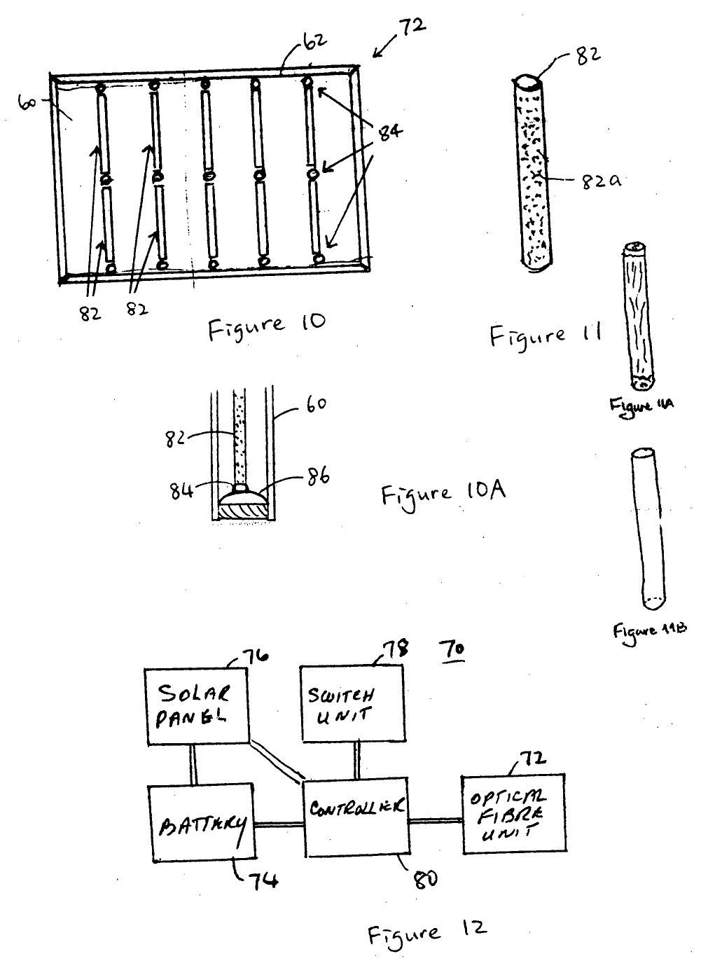

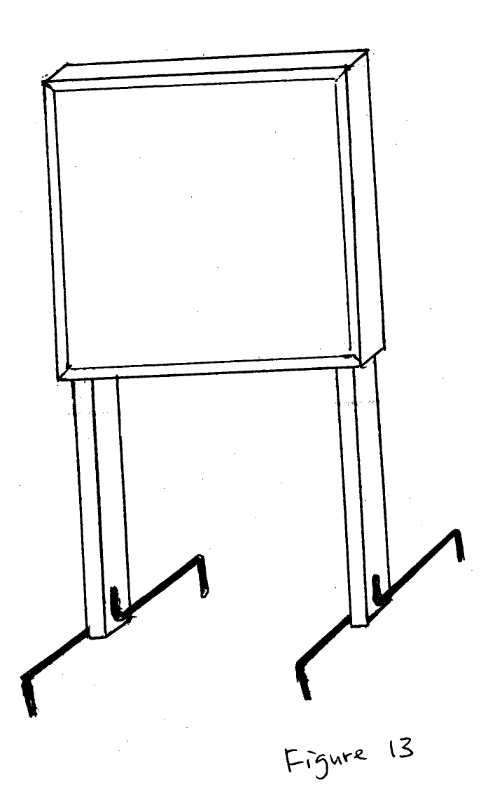

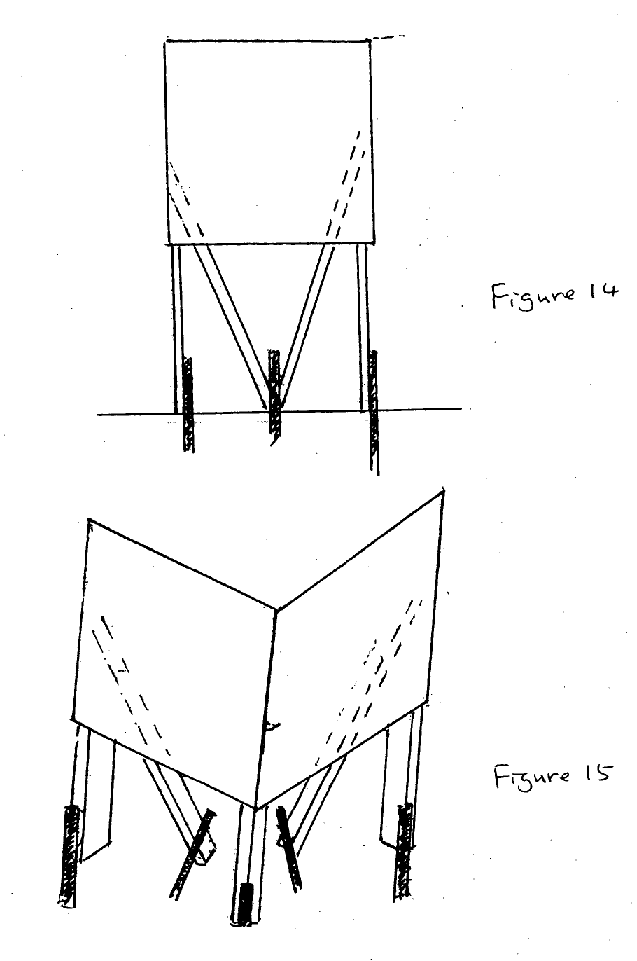

FIG. 12 shows an example of the lighting system 70. The optical fibre unit 72 is energized by the battery unit 74 through the controller 80. The battery unit 74 may contain one or more rechargeable batteries. The solar panel 76 is provided to recharge the battery unit 74.

The switching unit 78 may be a manual switch, a clock, a timer, a photo sensor or any combination thereof. The manual switch is operable by a user to turn on and/or off the optical fibre unit. The clock and timer may be used to switch on and/or off the optical fibre unit by preset time or preset intervals. The photo sensor may be used to turn on and/or off the optical fibre unit 72 depending on the ambient brightness.

The controller 80 controls the operation of the optical fibre unit 72, the battery unit 74 and the solar panel 76. The switching unit 78 determines if the battery unit 74 is to be charged or if the lighting unit is to be illuminated.

Referring back to FIG. 1, the battery unit 74, solar panel 76, switching unit 78 and controller 80 are typically accommodated within the hollow support 20. It is often suitable to accommodate most of these elements in the horizontal section 22 of the hollow support 20 and heavy components, such as battery unit 74, in the vertical section 24 near the lower end for the stability. A suitable weatherproof electrical connection joins components 74, 76, 78 and 80 to the panel unit 14.

In the above embodiments, the sign system uses the support having a single post. For a larger sign system or a sign system that is to be installed in an unstable location, more than one posts may be used as shown in FIGS. 13-15. One or more posts, as shown in FIG. 13, may be provided with an anchoring system similar to that described above. Different anchoring systems may be provided to different posts. The support may or may not have a horizontal section.

FIGS. 14 and 15 show examples of a one sided sign system.

While particular embodiments of the present invention have been shown and described, changes and modifications may be made to such embodiments without departing from the true scope of the invention. For example, the panel unit may use a single panel for presenting information, and the other panel may be used for covering the lighting unit. In that case, the sides of the optical fibre rods that are facing the single panel may be roughened and the other side may be kept smooth, but may be affixed with translucent tape or may be clear and smooth surfaced as the needs of illumination are met.

1. A sign system comprising:
a support having an anchoring system for anchoring the support to the ground;
a panel unit supported by the support, the panel unit having one or more sign panels for presenting information thereon; and
a lighting system having an optical fibre unit provided in the panel unit, the optical fibre unit having one or more optical fibre rods, each fibre rod having a peripheral surface that is capable of diffusing light therefrom.

2. The sign system as claimed in claim 1 wherein the anchoring system comprises a set of anchoring legs, each anchoring leg having a first section attached to the coupling member, a third section adaptable to be inserted into the ground, and a second section connecting the first and third sections.

3. The sign system as claimed in claim 2 wherein the angle between the first section and the second section of the anchoring leg is adjustable.

4. The sign system as claimed in claim 2 wherein the angle between the second section and the third section of the anchoring leg is adjustable.

5. The sign system as claimed in claim 2 wherein the anchoring system further comprises a coupling member to which the set of anchoring legs are secured in use.

6. The sign system as claimed in claim 2 wherein the angle between the first section and the second section of the anchoring leg is adjustable.

7. The sign system as claimed in claim 5 wherein the support has a hollow post through which the coupling member is received to hold the sign system.

8. The sign system as claimed in claim 1 wherein the peripheral surface of the fibre rod is roughened or affixed with translucent tape, or is clear and smooth as required for illuminating the sign panels.

9. The sign system as claimed in claim 1 wherein the lighting system has one or more convex reflecting materials to reflect light passed through the ends of the optical fibre rods towards the sign panels.

10. A method of installing a sign system as recited in claim 3, the method comprising the steps of:
adjusting the angle of each anchoring leg;
securing the anchoring system onto the ground;
mounting the support onto the anchoring system; and
providing the panel unit to the support.
